(19) United States
(12) Patent Application Publication
(10) Pub. No.: US 2018/0248638 A1
(43) Pub. Date: Aug. 30, 2018

(54) INFORMATION MANAGEMENT SYSTEM AND TIME INFORMATION CORRECTION METHOD

(71) Applicant: FUJITSU LIMITED, Kawasaki-shi (JP)

(72) Inventors: TOORU HARADA, Kawasaki (JP); SATOSHI YAMAJI, Kawasaki (JP)

(73) Assignee: FUJITSU LIMITED, Kawasaki-shi (JP)

(21) Appl. No.: 15/879,564

(22) Filed: Jan. 25, 2018

(30) Foreign Application Priority Data
Feb. 24, 2017 (JP) 2017-033715

(51) Int. Cl. H04J 3/06; G06Q 10/06

(52) U.S. Cl. CPC H04J 3/0638; G06Q 50/04; G06Q 10/0633

(57) ABSTRACT

An information management system includes: a first device that transmits information about production; and an information management device that manages the information received from the first device, wherein the information management device: obtains first time information indicated by a first internal clock of the first device and second time information indicated by a second internal clock of the information management device when the first time information is obtained; calculates a time difference between the first internal clock and the second internal clock in accordance with the first time information and the second time information; stores the time difference in a first storage in association with identification information of the first device; reads the time difference from the first storage when the information about production transmitted from the first device is used; and corrects the first time information added to the information about production based on the time difference.

### CROSS-REFERENCE TO RELATED APPLICATION

This application is based upon and claims the benefit of priority of the prior Japanese Patent Application No. 2017-033715, filed on Feb. 24, 2017, the entire contents of which are incorporated herein by reference.

### FIELD

The embodiments discussed herein are related to an information management system and a time information correction method.

### BACKGROUND

At production sites such as factories or the like, the usage of Internet of Things (IoT) has been progressing.

Related art is discussed in Japanese Laid-open Patent Publication No. 2012-216040.

### SUMMARY

According to an aspect of the embodiments, an information management system includes: a first device that transmits information about production; and an information management device that manages the information received from the first device, wherein the information management device; obtains first time information indicated by a first internal clock of the first device and second time information indicated by a second internal clock of the information management device when the first time information is obtained; calculates a time difference between the first internal clock and the second internal clock in accordance with the first time information and the second time information; stores the time difference in a first storage in association with identification information of the first device; reads the time difference from the first storage when the information about product ion transmitted from the first device is used; and corrects the first time information added to the information about production based on the time difference.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary information management system;

FIG. 2 illustrates an exemplary hardware configuration of a production management device;

FIG. 3 illustrates exemplary functional blocks of the production management device;

FIG. 4A illustrates an exemplary data structure of an information database (DB);

FIG. 4B illustrates an exemplary data structure of a time stamp;

FIG. 4C illustrates an exemplary data structure of a production device DB;

FIG. 5A illustrates an exemplary data structure of a delay time DB;

FIG. 5B illustrates an exemplary data structure of a time difference DB;

FIG. 6 illustrates exemplary processing of a reception unit;

FIG. 7 illustrates exemplary processing of a delay time calculation unit;

FIG. 8 illustrates exemplary processing of a time difference calculation unit;

FIG. 9 illustrates exemplary processing of an information processing unit;

FIG. 10 illustrates an exemplary time-difference calculation method and an exemplary time-difference usage method;

FIG. 11 illustrates an exemplary information management system;

FIG. 12 illustrates an exemplary information management system;

FIG. 13A illustrates an exemplary data structure of a time stamp; and

FIG. 13B illustrates an exemplary time-difference calculation method and an exemplary me-difference usage method.

### DESCRIPTION OF EMBODIMENTS

For example, information about a production status that is obtained in each of multiple production devices is collected in a production management device via a network. A service may be provided in which the production management device analyzes the collected information as big data and outputs the analysis result.

For example, production devices, are used for a long time in order to reduce capital investment. Therefore, the production devices include a production device, that transmits and receives information by using a communication standard (for example, Recommended Standard (RS)-232C, General Purpose Interface Bus (GPIB), or the like) which does not conform to the latest network function. In many cases, such a production device does not include a time synchronization function such as Network Time Protocol. In addition, when the production device operates in a state of being disconnected from an external network from a security viewpoint, a communication port may not be opened for a time synchronization function.

Thus, the production devices may include a production device in which a time indicated by an internal clock is inaccurate.

When the production management device collects information from each production device via the network, each of the production devices adds, to the information, identification information of the production device and information on a time at which the information has been obtained. The production management device sorts pieces of information by using time information as an index or analyzes occurrence of an event. In this case, when the production management device, uses information transmitted from a production device in which the time indicated by the internal clock is inaccurate, sorting of pieces of information and analysis of occurrence of an event may not be performed with high accuracy.

For example, an information management system or the like may be provided in which time information added to information on production is corrected with high accuracy.

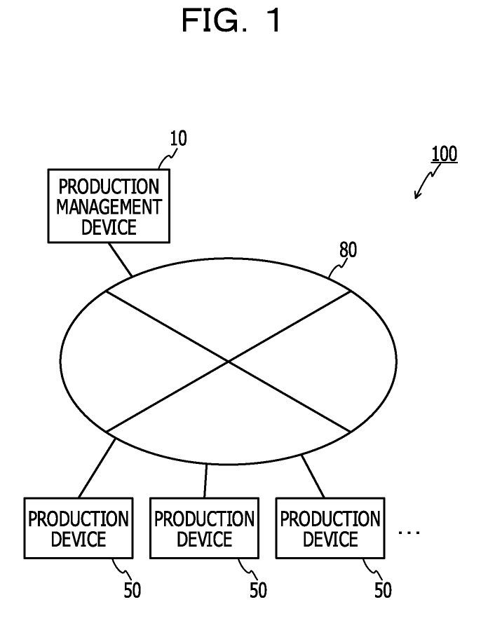

FIG. 1 illustrates an exemplary information management system.

As illustrated in FIG. 1, an information management system 100 includes a production management device 10 as an information management device and a plurality of production devices 50. The production management device 10 is coupled to each of the production devices 50 via a network (communication network) 80.

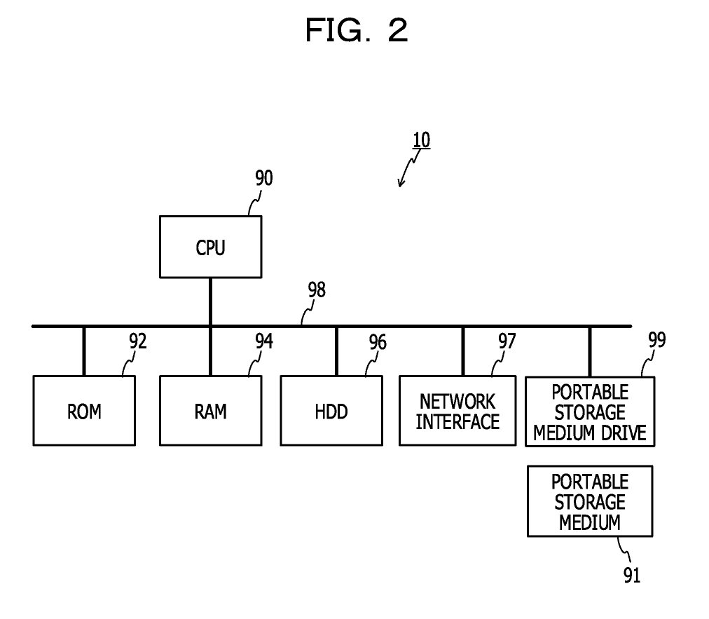

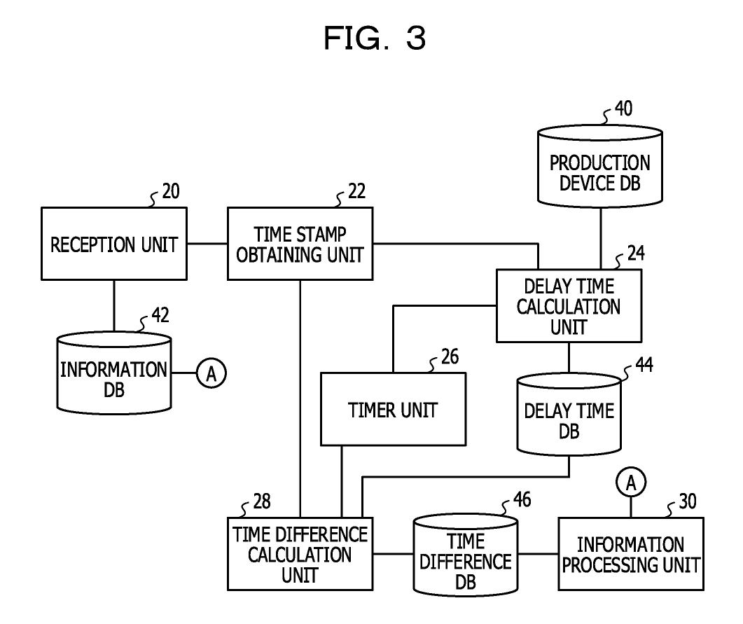

The production management device 10 is a device that collects information on production (log information) from each production device 50 via the network 80 and manages the production by the production device 50. FIG. 2 illustrates an exemplary hardware configuration of the production management device. FIG. 2 illustrates a hardware configuration of the production management device 10 illustrated in FIG. 1. As illustrated in FIG. 2, the production management device 10 includes a central processing unit (CPU) 90, a read only memory (ROM) 92, a random access memory (RAM) 94, a storage unit (ere, a hard disk drive (HDD)) 96, a network interface 97, and a portable storage medium drive 99. These units configured in the production management device 10 are coupled to a bus 98. In the production management device 10, functions of units illustrated in FIG. 3 are realized when the CPU 90 executes a program (including a time information correction program) stored in the ROM 92 or the HDD 96, or a program (including a time information correction program) that the portable storage medium drive 99 has read from a portable storage medium 91. Various databases (DBs) stored in the HDD 96 or the like of the production management device 10 are illustrated in FIG. 3.

FIG. 3 is a functional block diagram illustrating functions realized in the production management device 10 when the CPU 90 executes a program. As illustrated in FIG. 3, the production management device 10 realizes functions of a reception unit 20, a time stamp obtaining unit 22, a delay time calculation unit 24 as an identification unit and a second processing unit, a timer unit 26, a time difference calculation unit 28 as an obtaining unit and a first processing unit, and an information processing unit 30 as a correction unit.

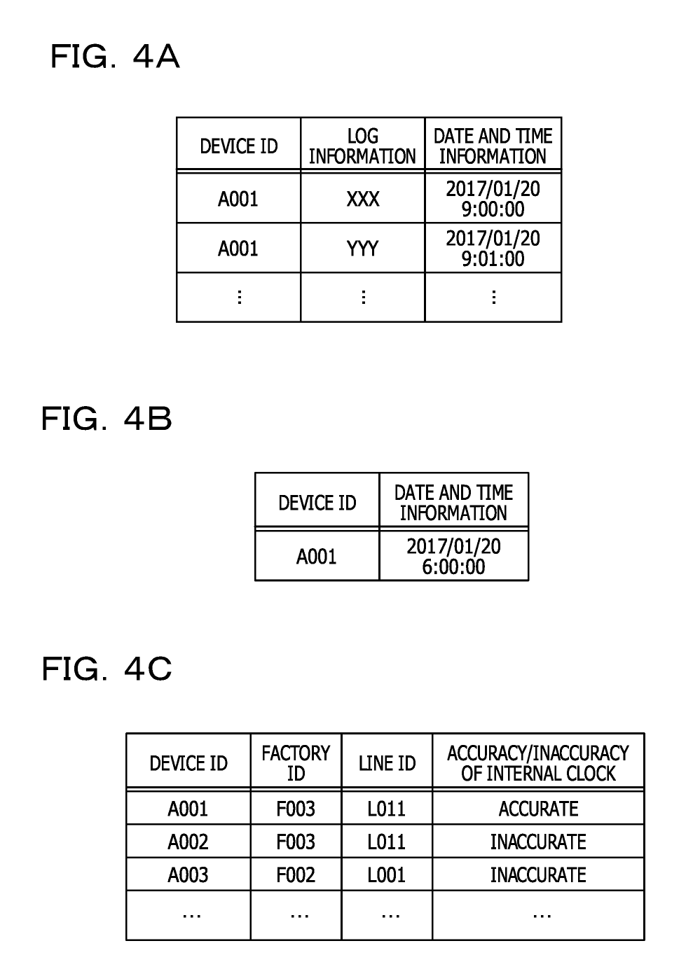

The reception unit 20 obtains information on production (for example, log information), which is transmitted from a production device 50, and stores the information in an information DB 42, When the reception unit 20 receives a time stamp from the production device 50, the reception unit 20 transmits the received time stamp to the time stamp obtaining unit 22. The information on production, which is transmitted from the production device 50, includes a device ID that is identification information of the production device 50, log information, and information indicating a date and time at which the production device 50 has obtained and transmitted the log information. The information on the date and time is information on a date and time indicated by the internal clock of the production device 50, and therefore, when the time indicated by the internal clock of the production device 50 is inaccurate, inaccurate date and time information is transmitted to the production management device 10. Here, the information DB 42 is a database that stores the information on production, which is transmitted from the production device 50, and as illustrated in FIG. 4A, includes fields of “device ID”, “log information”, and “date and time information”. Identification information of a production device 50 that is a transmission source is stored in the field of “device ID”, and log information itself that has been obtained in the production device 50 that is the transmission source is stored in the field of “log information”. Information on a date and time at which the log information has been obtained in the production device 50 that is the transmission source and has been transmitted to the production management device 10 is stored in the field of “date and time information”.

Returning to FIG. 3, when the internal clock of each production device 50 indicates a time (for example, 6:00:00 am) determined in advance, the time stamp obtaining unit 22 obtains, via the reception unit 20, a time stamp that has been transmitted from the production device 50 to the production management device 10. In addition, the time stamp obtaining unit 22 transmits the received time stamp to the delay time calculation unit 24 and the time difference calculation unit 28. FIG. 4B illustrates a data structure of a time stamp. As illustrated in FIG. 4B, the time stamp includes “device ID” data and “date and time information” data. For example, a production device 50 that has transmitted the time stamp and date and time information indicated by the internal clock of the production device 50 at timing at which the time stamp has been transmitted are identified by the time stamp.

The delay time calculation unit 24 calculates a delay time in communication between the production device 50 and the production management device 10, based on the time stamp that has been obtained in the time stamp obtaining unit 22. FIG. 4C illustrates a data structure of a production device DB 40 as a storage unit referred to by the delay time calculation unit 24. The production device DB 40 is a database in which information on the location of each production device 50 arranged and information indicating whether the internal clock of the production device 50 is accurate are managed, and as illustrated in FIG. 4C, the production device DB 40 includes fields of “device ID”, “factory ID”, “line ID”, and “accuracy/inaccuracy of the internal clock”. Identification information of a factory and identification information of a line in which the production device 50 is arranged are respectively stored in the fields of “factory ID” and “line ID”. It is assumed that production devices having a common line ID are production devices arranged in the same location, and production devices having a common factory ID are production devices arranged in similar locations. Information indicating whether the internal clock of the production device 50 is accurate is stored in the field of “accuracy/inaccuracy of the internal clock”. Here a production device 50 in which the time indicated by the internal clock is accurate is, for example, a device having a time synchronization function such as Network Time Protocol.

The delay time calculation unit 24 identifies a production device 50 (for example, a second device) in which the time indicated by the internal clock is accurate with reference to the production device DB 40 and calculates a delay time between the identified production device 50 and the production management device 10 by using the time stamp that has been transmitted from the identified production device 50. The delay time occurs due to the network 80 between the production device 50 and the production management device 10. For example, the delay time calculation unit 24 sets, as a delay time, a difference between date and time information of the time stamp that has been transmitted from the identified production device 50 and date and time information that has been obtained in the timer unit 26 when the delay time calculation unit 24 obtained the time stamp, which is substantially the same timing as a timing at which the reception unit 20 has received the time stamp. The delay time calculation unit 24 stores the obtained delay time and the identified production device 50, for example, in a delay time DB 44 as a second storage unit so as to associate the delay time with the identified production device 50. The delay time calculation unit 24 identifies a production device arranged in a location same as or similar to the location of the production device 50 for which the delay time has been calculated, and stores the calculated delay time in association the identified production device in the delay time DB 44.

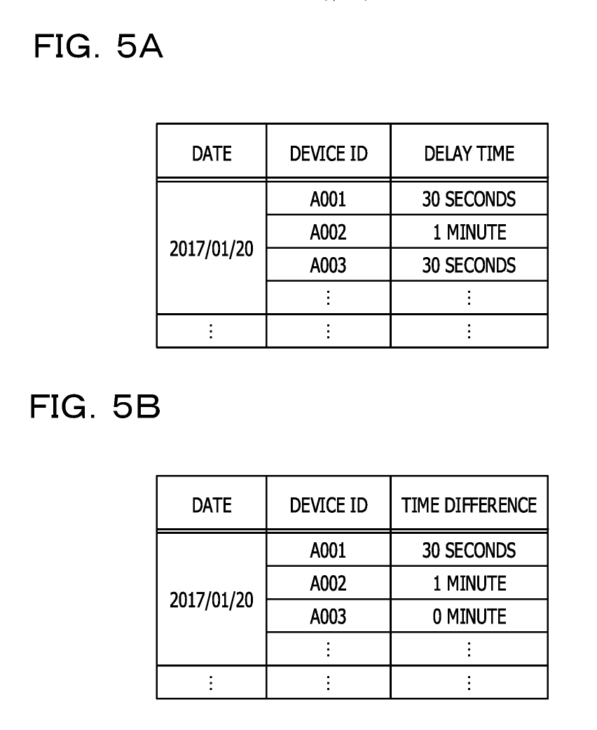

The delay time DB 44 is a database in which a delay time of each production device 50 is managed, and as illustrated in FIG. 5A, includes fields of “date”, “device ID”, and “delay time”. Information on date at which a delay time has been calculated is stored in the field of “date”, and identification information of the production device 50 is stored in the field of “device ID”. The delay time obtained in the delay time calculation unit 24 is stored in the field of “delay time”.

The timer unit 26 obtains date and time information with reference to the internal clock of the production management device 10, and transmits the obtained date and time information to the delay time calculation unit 24 and the time difference calculation unit 28. The production management device 10 includes, for example, a time synchronization function such as Network Time Protocol, and therefore the time indicated by the timer unit 26 (for example, the internal clock) is accurate.

The time difference calculation unit 28 calculates a time difference (difference from the accurate time) between the internal clock of the production device 50 and the internal clock of the production management device 10 in accordance with the time stamp that the reception unit 20 has received from the production device 50, date and time information that has been obtained in the timer unit 26 (for example, the internal clock) when the reception unit 20 has received the time stamp, and a delay time stored in the delay time DB 44. The time difference calculation unit 28 stores the calculated time difference for the production device 50 in a time difference DB 46 as a first storage unit.

The time difference DB 46 has a data structure illustrated in FIG. 5B. For example, as illustrated in FIG. 5B, the time difference DB 46 includes fields of “date”, “device ID”, and “time difference”. Information on date at which the time difference has been calculated is stored in the field of “date”, and identification information of the production device is stored in the field of “device ID”. A time difference for the production device 50, which has been obtained in the time difference calculation unit 28 is stored in the field of “delay time”.

When the information processing unit 30 uses log information stored in the information DB 42, the information processing unit 30 corrects date and time information added to the log information in accordance with a time difference stored in the time difference DB 46. In the case where the information processing unit 30 corrects date and time information, the information processing unit 30 reads a time difference for which log information corresponds to a date and a device ID, from the time difference DB 46, and corrects the date and time information in accordance with the read time difference. The information processing unit 30 sorts pieces of log information in accordance with the corrected date, and time information and analyzes occurrence of an event.

Returning to FIG. 1, the production device 50 may be, for example, a programmable logic controller (PLC), a computer numerical control (CNC), a robot controller, or the like. The production device 50 executes processing of each device, and transmit information on production (log information) to the production management device 10 and transmits a time stamp (see FIG. 4B) to the production management device 10 at a specific time (for example, everyday at 6:00:00 am).

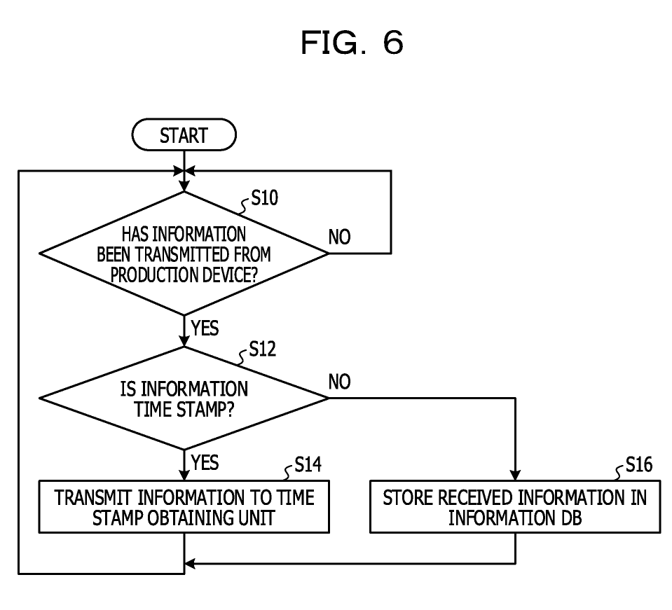

FIG. 6 illustrates exemplary processing of the reception unit 20. In Operation S10 of FIG. 6, the reception unit 20 waits until information (for example, log information or time stamp) is transmitted from the production device 50. When the information is transmitted, from the production device 50, the processing proceeds to Operation S12.

When the processing proceeds to Operation S12, the reception unit 20 determines whether the information that has been transmitted from the production device 50 is a time stamp. When “Yes” is determined in Operation S12 (for example, when the information is a time stamp), the processing proceeds to Operation S14, and when “No” is determined in Operation S12 (for example, when the in nation is log information), the processing proceeds to Operation S16.

When the processing proceeds to Operation S14, the reception unit 20 transmits the received time stamp to the time stamp obtaining unit 22. When the time stamp obtaining unit 22 receives the time stamp, the time stamp obtaining unit 22 transmits the received time stamp to the delay time calculation unit 24 and the time difference calculation unit 28.

When the processing proceeds to Operation S16, the reception unit 20 stores the received log information in the information DB 42.

After the processing of Operations S14 or S16 has been executed, the processing returns to Operation S10, and the reception unit 20 repeatedly executes the above-described processing.

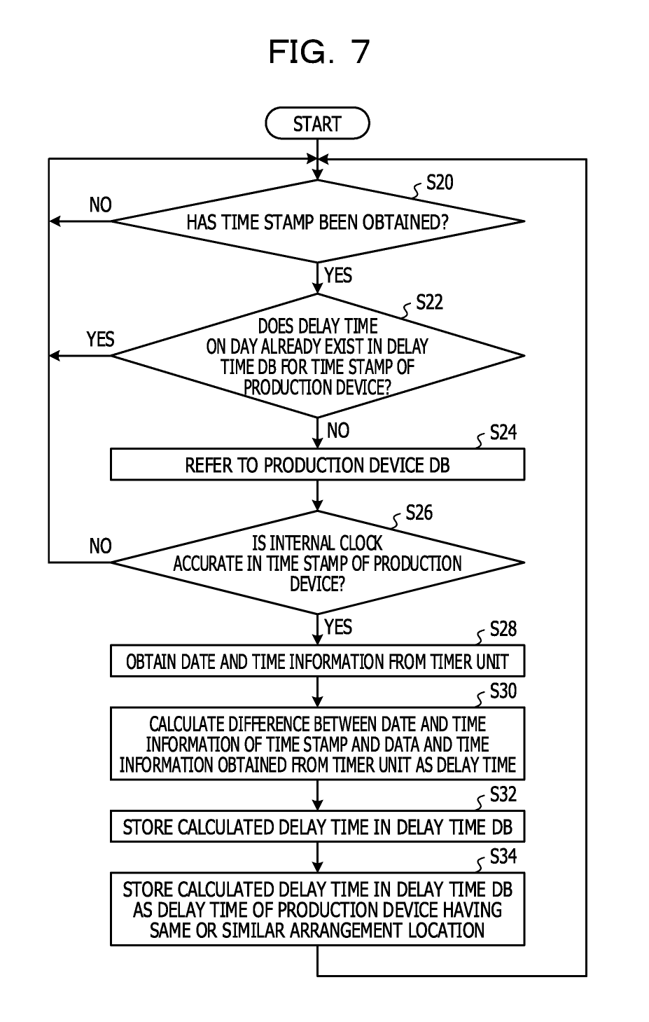

FIG. 7 illustrates exemplary processing of the delay time calculation unit 24.

In Operation S20 of FIG. 7, the delay time calculation unit 24 waits until a time stamp is obtained from the time stamp obtaining unit 22. When the delay time calculation unit 24 obtains a time stamp from the time stamp obtaining unit 22, the delay time calculation unit 24 causes the processing to proceed to Operation S22 and determines, with reference to the delay time DB 44, whether a delay time on the day when the production device 50 has transmitted the time stamp to the production management device 10 already exists in the delay time DB 44. For example, the delay time calculation unit 24 extracts a device ID included in the time stamp and checks whether a delay time on that day, which corresponds to the extracted device ID, already exists in the delay time DB 44. When “Yes” is determined in Operation S22, it is unnecessary to newly obtain a delay time, and the processing returns to Operation S20. When “No” is determined in Operation S22, the processing proceeds to Operation S24, and the delay time calculation unit 24 refers to the production device DB 40, In this case, the delay time calculation unit 24 determines whether the time (for example, the internal clock) indicated by the production device 50 that has transmitted the time stamp is accurate.

In Operation S26, the delay time calculation unit 24 determines whether the obtained time stamp is a time stamp that has been transmitted from a production device 50 in which the time indicated by the internal clock is accurate. When “No” is determined in Operation S26, it is difficult to calculate a delay time from the obtained time stamp, and the processing returns to Operation S20, but when “Yes” is determined in Operation S26, the processing proceeds to Operation S28.

When the processing proceeds to Operation S28, the delay time calculation unit 24 obtains date and time information from the timer unit 26. When the processing proceeds to Operation S28, both the date and time information of the obtained time stamp and the date and time information of the timer unit 26 are accurate.

In Operation S30, the delay time calculation unit 24 calculates, as a delay time, a difference between the date and time information of the time stamp and the date and time information that has been obtained from the timer unit 26. For example, when the date and time information of the time stamp (for example, a time) is “9:00:00”, and the date and time information that has been obtained from the timer unit 26 (for example, a time) is “9:00:30”, a difference between the times, for example, “30 seconds” represent a delay time.

In Operation S32, the delay time calculation unit 24 stores the calculated delay time in the delay time DB 44.

In Operation S34, the delay time calculation unit 24 stores the calculated delay time in the delay time DB 44 as a delay time of a production device 50 arranged in a location same as or similar to the location of the production device 50 for which the delay time has been calculated. For example, the delay time calculation unit 24 identifies, with reference to the production device DB 40, a production device 50 having the same factory ID as the production device 50 for which the delay time has been calculated in Operation S30, and stores in the delay time DB 44 the delay time calculated in Operation S30 in association with a device ID of the identified production device 50. After the processing of Operation S34 has been executed, the processing returns to Operation S20, and the above-described processing is repeatedly executed. For example, when a single specific time at which a time stamp is transmitted is set in each production device 50, a delay time for the production device 50 is calculated once a day.

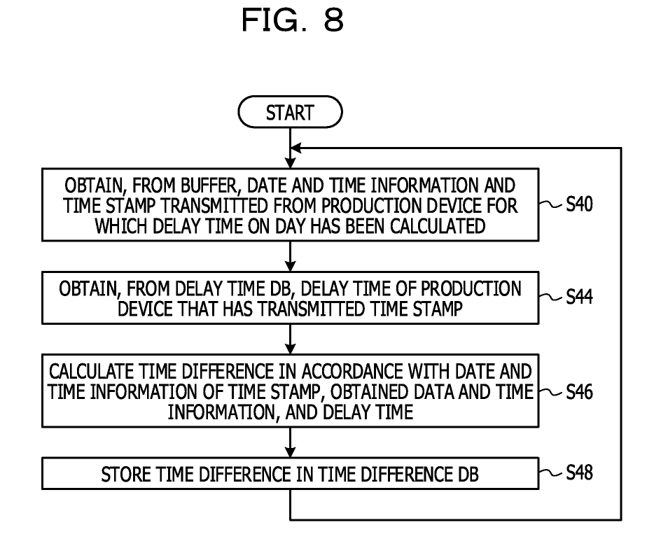

FIG. 8 illustrates exemplary processing of the time difference calculation unit 28. The time difference calculation unit 28 temporarily stores in a buffer a time stamp that has been obtained from the reception unit 20 and date and time information when the time stamp has been obtained from the timer unit 26, in parallel with the processing of FIG. 8.

In Operation S40 of FIG. 8, the time difference calculation unit 28 identifies a production device 50 for which the delay time of the day is already stored in the delay time DB 44, and obtains, from the buffer, a time stamp that the identified production device 50 has transmitted on that day and date and time information. The time stamp and the date and time information obtained from the buffer are deleted from the buffer.

In Operation S44, the time difference calculation unit 28 obtains a delay time of the production device 50 that has transmitted the obtained time stamp, from the delay time DB 44.

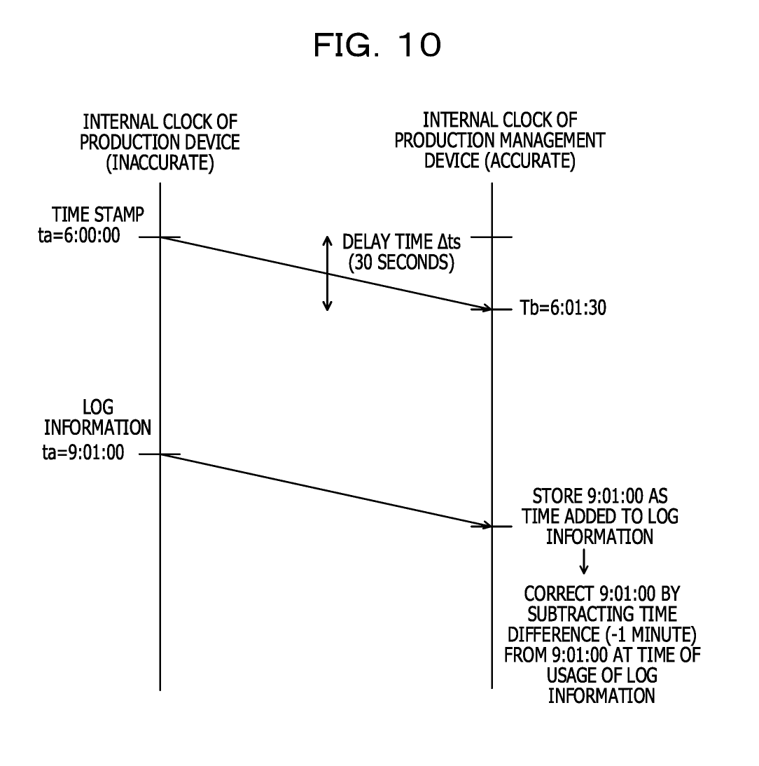

In Operation S46, the time difference calculation unit 28 calculates a time difference in accordance with the date and time information of the time stamp, the obtained date and time information, and the delay time stored in the delay time DB 44. FIG. 10 illustrates an exemplary time-difference calculation method and an exemplary time-difference usage method.

As illustrated in FIG. 10, it is assumed that date and time information ta of the internal clock of the production device 50 is inaccurate, and date and time information Tb of the internal clock of the production management device 10 is accurate. In this case, a time difference T between the date and time information of the internal clock of the production device 50 and the accurate date and time is obtained in accordance with the following equation (1) by using a delay time as “Δts”.

T=ta−(Tb−Δts) (1)

In FIG. 10, the time difference T becomes “T=6:00:00−(6:01:30−30 seconds)=−1 minute”.

Returning to FIG. 8, in next Operation S48, the time difference calculation unit 28 stores in the time difference DB 46 the time difference that has been obtained in Operation S46. In this case, the time difference calculation unit 28 stores in the time difference DB 46 the time difference in association with a device ID and a date. After that, the processing returns to Operation S40, and the time difference calculation unit 28 repeatedly executes the above-described processing. When a single specific time at which a time stamp is transmitted is set in each production device 50, a time difference for the production device 50 is calculated once a day.

A time difference may not be calculated for a production device 50 in which the time indicated by the internal clock is accurate. In this case, it is sufficient that the time difference calculation unit 28 refers to the production device DB 40 after having obtained the time stamp in Operation S40, and “0” is stored in the time difference DB 46 as the time difference for the production device 50 without execution of Operations S44 to S48 when a time (for example, the internal clock) when the production device 50 has transmitted the time stamp is accurate.

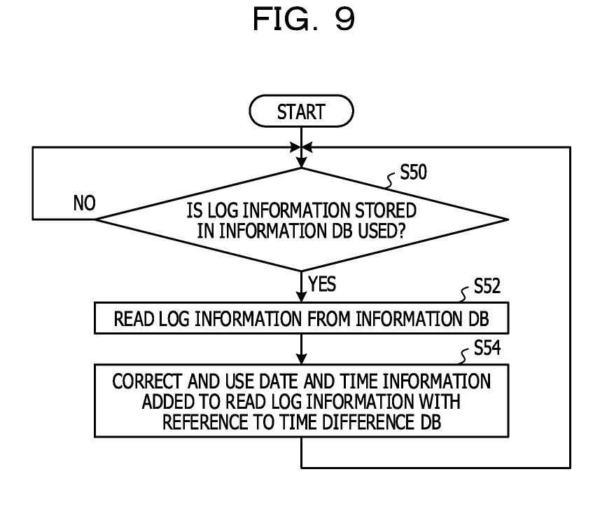

FIG. 9 illustrates exemplary processing of the information processing unit 30.

In Operation S50, the information processing unit 30 determines whether log information stored in the information DB 42 is used. When “No” is determined in Operation S50, the information processing unit 30 repeatedly executes Operation S50, but when “Yes” is determined in Operation S50, the processing proceeds to Operation S52.

When the processing proceeds to Operation S52, the information processing unit 30 reads the log information, from the information DB 42.

In Operation S54, the information processing unit 30 corrects date and time information added to the read log information with reference to the time difference DB 46 and uses the log information. For example, in the example of FIG. 10, it is assumed that the date and time information (time) added to the log information is “9:01:00”. In this case, in the information DB 42, the time “9:01:00” is stored without any change as date and time information (time) to added to the log information. In addition, it is assumed that, “−1 minute” is stored, in the time difference DB 46, as the time difference T in a day in which the log information to be used has been obtained. Here, when the log information is used, the information processing unit 30 corrects a time “9:01:00” stored in the information DB 42 to “9:02:00” by subtracting “time difference T=1 minute” from the time “9:01:00”. In this case, date and time information To after the correction may be expressed by the following equation (2).

Te=ta−T (2)

After that, the processing returns to Operation S50, and the information processing unit 30 repeatedly executes the above-described processing.

In the processing of FIG. 9, the information processing unit 30 determines, with reference to the production device DB 40, whether the date and time information added to the log information that has been read from the information DB 42 is accurate date and time information and when the date and time information added to the read log information is accurate, the date and time information added to the read log information may be used without any change without reference to the time difference DB 46.

The information management system 100 includes the production devices 50 each of which transmits information on production (log information) and the production management device 10 that manages information received from the production devices 50. The time difference calculation unit 28 of the production management device 10 obtains date and time information (for example, a time stamp) transmitted from each of the production devices 50, obtains, from the timer unit 26, date and time information indicated by the internal clock of the production management device 10 when the time stamp has been obtained, calculates a time difference T between the internal clock of each of the production devices 50 and the internal clock of the production management device 10 in accordance with the obtained information, and stores the calculated time difference T in the time difference DB 46 in association with a device ID of each of the production devices 50. When the information processing unit 30 uses the information (for example, log information) transmitted from each of the production devices 50, the information processing unit 30 reads the time difference T from the time difference DB 46 and corrects the date and time information to added to the log information by using the read time difference T. As a result, a time difference between the accurate internal clock of the production management device 10 and the internal clock of each of the production devices 50 is managed, and the date and time information added to the log information is corrected in accordance with the time difference corresponding to each of the production devices 50 when the log information transmitted from each of the production devices 50 is used, and therefore, the date and time information added to the log information is corrected with high accuracy. Therefore, the information transmitted from the production device 50 may be used appropriately (for example, pieces of log information are sorted by date and time information, and occurrence of an event is analyzed). Thus, even when the production device 50 does not include a time synchronization function such as Network Time Protocol, log information may be used appropriately, and therefore, IoT may be realized while reducing capital investment. Information (for example, raw data) stored in the information DB 42 is not changed, and therefore, log information may be used appropriately while the raw data remains intact.

The delay time calculation unit 24 of the production management device 10 identifies a production device 50 in which date and time information transmitted is accurate, with reference to the production device DB 40 and calculates a delay time Δts in accordance with a time stamp (for example, date and time information) transmitted from the identified production device 50 and, date and time information indicated by the internal clock of the production management device 10 when the time stamp has been obtained, and stores the calculated delay time Δts in the delay time DB 44 in association with identification information (device ID) of the identified production device 50. The delay time calculation unit 24 identifies, with reference to the production device DB 40, a production device 50 the arrangement location of which is the same as or similar to that of the production device 50 for which the delay time has been calculated, and stores the calculated delay time Δts in the delay time DB 44 in association with the identified production device 50. The time difference calculation unit 28 reads the delay time Δts of the production device 50 from the delay time DB 44, calculates a time difference T between the internal clock of the production device 50 and the internal clock of the production management device 10 in accordance with the read delay time Δts and the pieces of date and time information ta and Tb, and stores the calculated time difference T in the time difference DB 46 in association with the device ID of the production device 50. As a result, a delay time between the production device 50 and the production management device 10 is calculated with high accuracy. By using the delay time calculated with high accuracy, a time difference between the internal clock of the production devices 50 and the internal clock of the production management device 10 is calculated with high accuracy.

The production management device 10 includes the delay time calculation unit 24, and the delay time calculation unit 24 calculates a delay time of each production device 50, but the embodiment is not limited to such an example. For example, the delay time DB 44 may be prepared in advance in accordance with the arrangement location or the like of the production device 50. In the case where the delay may be negligible because a communication speed in the network 80 is fast, the time difference calculation unit 28 may calculate a time difference with no delay time (Δts=0).

The information processing unit 30 does, not change date and time information corresponding to information (for example, raw data) stored in the information DB 42 (does not update the information DB 42 by the date and time information after the correction), but the embodiment is not limited to such an example. For example, the information processing unit 30 may update the information DB 42 by the date and time information after the correction.

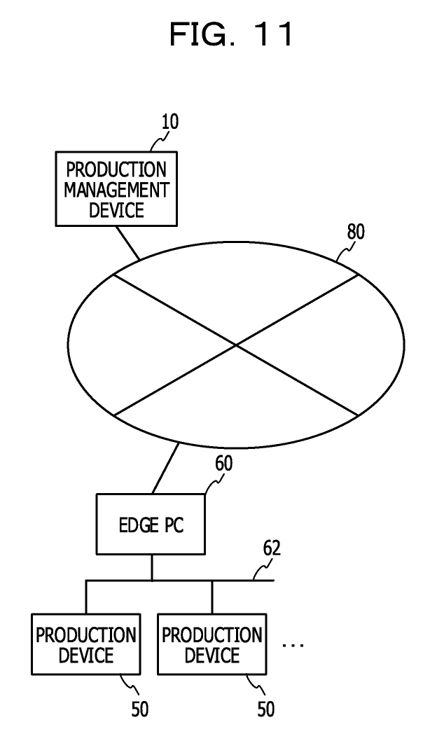

The production device 50 is directly coupled to the network 80, but the embodiment is not limited to such an example. For example, as illustrated in FIG. 11, a production device 50 may be coupled to a network 62 in a factory and coupled to a production management device 10 via an edge PC 60 coupled to the network 62 in the factory. In this case, the edge PC 60 may add data and time information indicated by the internal clock of the edge PC 60 to the log information transmitted from the production device 58 and transmit the log information to the production management device 10. In addition, the edge PC 60 may transmit a time stamp (for example, information indicating a specific time) to the production management device 10 when the internal clock indicates the specific time. In this case, even when the edge PC 60 does not include a time synchronization function, the information transmitted from the production device 50 is used appropriately by execution of processing similar to the above-described processing in the production management device 10.

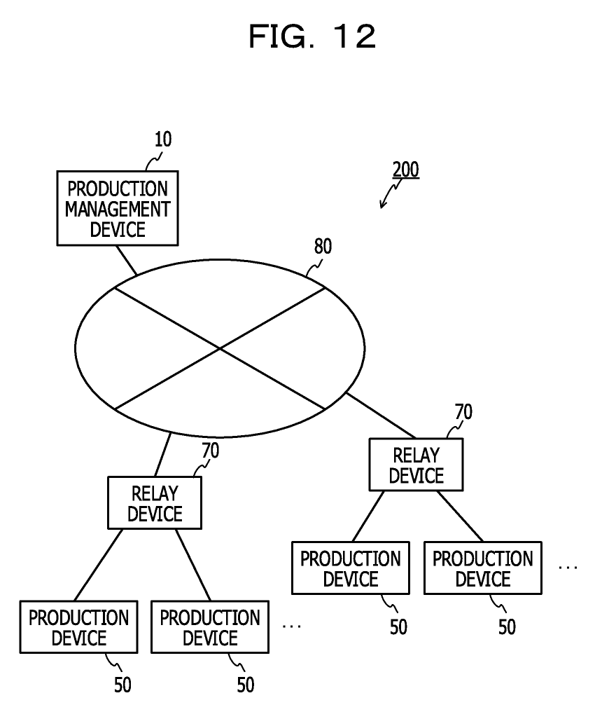

FIG. 12 illustrates an exemplary information management system. In the information management system 200, as illustrated in FIG. 12, a production device 50 is coupled to a network 80 via a relay device 70.

The relay device 70 is a device in which the time indicated by the internal clock is accurate, and a plurality of production devices 50 is coupled to the relay device 70. When the production device 50 transmits a time stamp indicating a specific time to the production management device 10, the relay device 70 adds accurate date and time information indicated by the internal clock of the relay device 70 to the time stamp, and transmits the time stamp to the production management device 10.

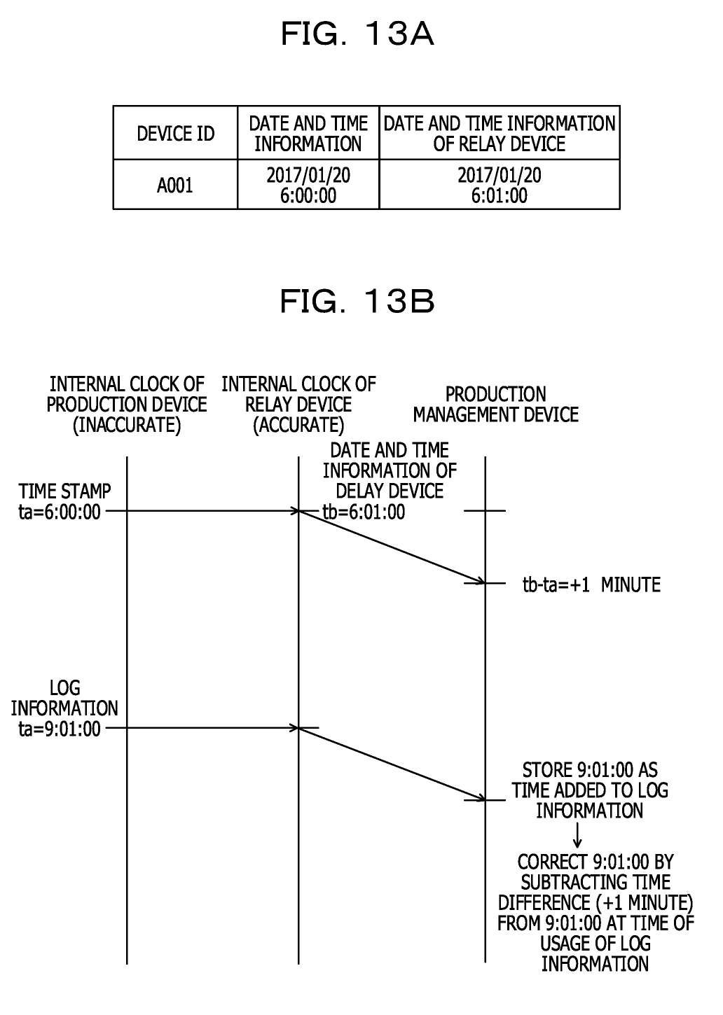

FIG. 13A illustrates a data structure of a time stamp, As illustrated in FIG. 13A, a time stamp includes “device ID” that is identification information of a production device 50, “date and time information” that is a date and time (for example, a specific time) indicated by the internal clock of the production device 50, and “date and time information of the relay device” that is a date and time (for example, an accurate time) indicated by the internal clock of the relay device 70. FIG. 13A indicates that the production device 50 is delayed by one minute compared to the accurate time.

As illustrated in FIG. 13B, in the production management device 10, the time difference calculation unit 28 obtains a time difference (+1 minute in FIG. 13B) between the date and time information to of the production device 50 and the date and time information tb (for example, an accurate time) of the relay device 70 in accordance with the time stamp and stores the time difference in the time difference DB 46. In addition, in the production management device 10, when information (for example, log information) has been transmitted from the production device 50, date and time information added to the log information is stored in the information DB 42 without any change (as “ta”). When the log information stored in the information DB 42 is used, the information processing unit 30 corrects date and time information added to the log information by using the time difference stored in the time difference DB 46. For example, as illustrated in FIG. 138, when the date and time information (time) added to the log information is “9:01:00”, the time “9:01:00” is corrected to “9:00:00” such that a “time difference+1 minute” is subtracted from “9:01:00” and the log information is used.

In the information management system illustrated in FIG. 1, the network 80 exists between the production management device 10 including the internal clock the time of which is accurate and the production device 50 including the internal clock the time of which is likely to be inaccurate, and therefore, a delay time in the network 80 is considered when the time difference is calculated. In the information management system illustrated in FIG. 12, the network 80 does not exist between the production device 50 and the relay device 70, and a delay time between the production device 50 and the relay device 70 may be a level to be ignored, and therefore, it is unnecessary to consider a delay time in the calculation of a time difference.

In the information management system illustrated in FIG. 12, the relay device 70 is arranged between the production device 50 and the network 80, and when the relay device 70 receives a time stamp transmitted from the production device 50 to the production management device 10, the relay device 70 adds date and time information indicated by the internal clock to the time stamp and transmits the time stamp to the production management device 10. When the information (for example, log information) transmitted from the production device 50 is used in the production management device 10, the production management device 10 corrects the date and time information added to the used information by using a time difference between the date and time information indicated by the internal clock of the production device 50 and the date and time information indicated by the internal clock of the relay device 70. As a result, even when the internal clock of the production device 50 is inaccurate, as long as the time indicated by the internal clock of the relay device 70 is accurate, a time difference between the time indicated by the internal clock of the production device 50 and the accurate time may be obtained with high accuracy. Thus, when the date and time information added to the information is corrected by using the time difference obtained with high accuracy, the log information may be used appropriately. Even when the production device 50 does not include a time synchronization function such as Network Time Protocol, the log information may be used appropriately, and therefore, IoT may be realized while reducing capital investment. Information stored in the information DB 42 (for example, raw data) is not changed, and therefore, the information may be used appropriately while raw data remains intact.

The information processing unit 30 may update the information DB 42 by using the date and time information after the correction.

As described above, the production device 50 transmits a time stamp to the production management device 10 at a specific time, and the production management device 10 calculates a time difference and a delay time by using the time stamp, but the embodiment is not limited to such an example. For example, a time difference and a delay time may be calculated by using date and time information added to log information that the production device 50 transmits first in a day as described above.

The above-described processing function may be realized by a computer. In this case, a program is provided in which a processing content of a function that is to be included in the processing device is described. When the program is executed in the computer, the above-described processing function is realized on the computer. The program in which the processing content is described may be recorded in a computer-readable recording medium (except for carrier waves).

When the program is distributed, for example, the program is sold in the form of a portable recording medium such as a digital versatile disc (DVD) or a compact disc read only memory (CD-ROM) in which the program is recorded. In addition, the program may be stored in a storage device of a server computer and transferred to another computer from the server computer via a network.

The computer that executes a program stores, for example, a program recorded in the portable recording medium or a program transferred from the server computer, in the storage device of the computer. The computer reads the program from the storage device and executes processing in accordance with the program. The computer may directly read a program from the portable recording medium, and execute processing in accordance with the program. In addition, the computer may execute processing in accordance with a received program sequentially each time the program is received from the server computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information management system comprising:
a first device that transmits information about production; and
an information management device that manages the information received from the first device, wherein
the information management device:
obtains first time information indicated by a first internal clock of the first device and second time information indicated by a second internal clock of the information management device when the first time information is obtained;
calculates a time difference between the first internal clock and the second internal clock in accordance with the first time information and the second time information;
stores the time difference in a first storage in association with identification information of the first device;
reads the time difference from the first storage when the information about production transmitted from the first device is used; and
corrects the first time information added to the information about production based on the time difference.

2. The information management system according to claim 1, wherein the information management device:
identifies a second device which transmits third time information that is accurate and a third device having an arrangement location the same as or similar to an arrangement location of the second device, by refereeing a second storage that stores arrangement information indicating an arrangement location of a device and information indicating whether time information transmitted from the device is accurate in associated with the identification information of the device;
calculates a delay time between the information management device and the second device in accordance with the third time information indicated by a third internal clock of the second device and the second time information indicated by the second internal clock when the third time information is obtained; and
stores the delay time in a third storage in association with identification information of the second device and identification information of the third device.

The information management system according to claim 2, wherein the information management device:
reading a delay time of the first device from the third storage;
calculating the time difference between the first internal clock and the second internal clock in accordance with the read delay time, the first time information, and the second time information; and
storing the time difference in the first storage in association with the identification information of the first device.

4. An information management system comprising:
a first device that transmits information about production;
an information management device that manages the information received from the first device via a communication network; and
a relay device, provided between the first device and the communication network, that adds accurate second time information to first time information indicated by a first internal clock of the first device, the first time information being transmitted from the first device to the information management device, and transmits the first time information, to which the accurate second time information is added, to the information management device when the first time information is received from the first device, wherein
the information management device:
calculates a time difference between the firs time information and the second time information;
stores the time difference in a storage in association with identification information of the first device; and
reads, when the information about production transmitted from the first device is used, the time difference corresponding to the first device from the storage; and
corrects time information added to the information about production based on the time difference.

5. A time information correction method comprising:
obtaining first time information indicated by a first internal clock of a first device, which transmits information about production, and second time information indicated by a second internal clock of a information management device, which manages the information received from the first device, when the first time information is obtained;
calculating, by a computer, a time difference between the first internal clock and the second internal clock in accordance with the first time information and the second time information;
storing the time difference in a first storage in association with identification information of the first device;
reading the time difference from the first storage when the information about production transmitted from the first device is used; and
correcting the first time information added to the information about production based on the time difference.

6. The time information correction method according to claim 5, further comprising:
identifying a second device which transmits third time information that is accurate and a third device having an arrangement location the same as or similar to an arrangement location of the second device, by refereeing a second storage that stores arrangement information indicating an arrangement location of a device and information indicating whether time information transmitted from the device is accurate in associated with the identification information of the device;
calculating a delay time between the information management device and the second device in accordance with the third time information indicated by a third internal clock of the second device and the second time information indicated by the second internal clock when the third time information is obtained; and
storing the delay time in a third storage in association with identification information of the second device and identification information of the third device.

7. The time information correction method according to claim 6, further comprising:
reading a delay time of the first device from the third storage;
calculating the time difference between the first internal clock and the second internal clock in accordance with the read delay time, the first time information, and the second time information; and
storing the time difference in the first storage in association with the identification information of the first device.
